(19) United States
(12) Patent Application Publication
(10) Pub. No.: US 2006/0019632 A1
(43) Pub. Date: Jan. 26, 2006

(54) Dedicated wireless device business method

(75) Inventors: Ivy Cunningham, Seattle, WA (US); Stacia Lynn Pache, Redmond, WA (US); James L. Cannon, Bellevue, WA (US); Michael Bosland, Kirkland, WA (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: AT&T Wireless Services, Inc., Redmond, WA (US)

(21) Appl. No.: 10/940,576

(22) Filed: Sep. 14, 2004

Related U.S. Application Data
(60) Provisional application No. 60/590,185, filed on Jul. 21, 2004.
(60) Provisional application No. 60/590,229, filed on Jul. 21, 2004.
(60) Provisional application No. 60/587,792, filed on Jul. 12, 2004.
(60) Provisional application No. 60/588,018, filed on Jul. 12, 2004.
(60) Provisional application No. 60/588,307, filed on Jul. 15, 2004.
(60) Provisional application No. 60/588,110, filed on Jul. 15, 2004.

(51) Int. Cl. H04M 11/00

(52) U.S. Cl. 455/408; 455/406

(57) ABSTRACT

A business model that is dedicated to supporting a wireless messaging device. The model offers unlimited services on a dependent device, including mixed limited/unlimited usage models, pre-and post-pay models, and models not found in a conventional monthly recurring charge system. The model further includes components that address service selection, suspension, resumption, service add-ons, account limitations and restrictions, detect device compatibility with support services, account analysis, charging cycles, billing methods, third-party add-ons and interfacing, and troubleshooting support.

### CROSS-REFERENCE TO RELATED APPLICATIONS

This application claims the benefit of the following U.S. Provisional Patent Applications: Ser. No. 60/590,185 entitled “DEDICATED WIRELESS DEVICE BUSINESS METHOD” and filed Jul. 21, 2004, Ser. No. 60/590,229 entitled “ALWAYS-ON MOBILE INSTANT MESSAGING OF A MESSAGING CENTRIC WIRELESS DEVICE” filed on Jul. 21, 2004, and Ser. No. 60/587,792 entitled “SELECTION OF BEARER MODE ACCORDING TO MESSAGE CHARACTERISTICS” filed on Jul. 11, 2004; and is related to U.S. Provisional Patent Application Ser. No. 60/588,018 entitled “MAINTAINING INSTANT MESSAGE SESSION STATUS IN DYNAMIC OPERATING ENVIRONMENTS” filed on Jul. 11, 2004, Ser. No. 60/588,307 entitled “USING EMOTICONS, SUCH AS FOR WIRELESS DEVICES” filed on Jul. 15, 2004, and Ser. No. 60/588,110 entitled “CUSTOMER SERVICE MESSAGING, SUCH AS ON MOBILE DEVICES” filed on Jul. 15, 2004. The entireties of the above-noted applications are incorporated herein by reference.

### TECHNICAL FIELD

This invention is related to a business method for providing and accounting for wireless messaging services.

### BACKGROUND OF THE INVENTION

Mobile communications technology is rapidly advancing the exchange of information between users and systems. The user is no longer tied to a stationary device such as a personal computer in order to quickly message another user.

Instant Messaging (IM) is a technology that allows users to send and receive short text messages in realtime over IP networks. It also allows the user and/or messaging device to signal their online presence to others. IM has been in general use for some time, beginning with a product known as ICQ™ by ICQ, Inc., a messaging service now offered in a variety of flavors and used for many purposes, both commercial and personal, that take advantage of the real time messaging capability and presence management features of IM.

Though IM is perceived by users to be a Peer-to-Peer (P2P) application, directly connecting the user with chat “buddies”, IM actually depends upon a client-server architecture to facilitate those apparently direct interactions. When logging on, the user IM software client tells the IM server who the user is and where the user is via a screen name and current IP address. The server then updates its directory information to indicate that the user is online and available. The server shows the user which buddies are online, and it lets people who have added the user to their buddy lists, see that the user is online. Unlike e-mail and other asynchronous collaboration tools, IM works in real time, giving the user a channel to buddies that hides their contact details, as well as, their physical location and mode of connection (e.g., laptop, Palm device, and mobile phone).

It is natural for mobile users to desire access to mail and communicate in a data-centric manner while mobile. Messaging is used for quick person-to-person social coordination, often involves time-sensitive information, and utilizes presence indicators to help users keep track of their friends' status. Additionally, there is a strong demand for mobile messaging services. Nearly half of all IM users indicate that the option to use IM while mobile is desirable. Moreover, mobile e-mail is one of the top applications on mMode™ today. mMode, by AT&T Wireless Services, Inc., converges e-mail, Internet-based content, games, and more all in one device, e.g., the wireless telephone.

However, given that most wireless devices are voice-centric with the addition of some messaging capabilities, there is an unmet need in the market today for an improved business model that supports a dedicated wireless messaging device, for example, a wireless messaging-centric device that focuses on e-mail, instant messaging, text messaging, and other messaging technologies. There is a further unmet need in a business model that introduces flexible models to accommodate a variety of different devices for not only post-pay methods, but also pre-pay methods, and for mixed unlimited/limited data services, for example.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention disclosed and claimed herein, in one aspect thereof, comprises a novel business model for offering unlimited services on dependent devices, including mixed limited/unlimited usage models, pre- and post-pay models, and models that do not work on a standard monthly recurring system.

Applying the model to a wireless device that has dedicated, limited functionality allows for more creative business models. There are a number of ways to simplify billing and usage scenarios based on various scenarios described herein. The device can also have both dedicated, limited functionality in some aspects, and unlimited functionality in others. The device business model supports either prepaid (pre-payment) or postpaid (post-payment) methods. The following methods can be used to manage both end-user and provider costs, exposure, risk, and value added services. One such supported device is a dedicated Wireless Messaging Device (WMD). The business model plans for the WMD can include the following terms and variations.

A post-paid model is provided that involves a single monthly recurring charge (MRC) that can include some or all of the following services: unlimited domestic peer-to-peer mobile-originated (MO) and mobile-terminated (MT) text messaging, unlimited instant messaging (IM) through a native IM client, unlimited POP3 e-mail to preexisting Internet-accessible POP3 accounts, access to one value-added portal (VAP-a 3^{rd} party portal provider), access to additional VAPs for an additional monthly fee, a voice service ‘bolt-on’ at standard voice rates, International MO SMS messages at an additional fee, additional services at additional MRC, per-use, or volume-based pricing separate and independent of other MRCs, automatic recurring credit card, EFT (Electronic Funds Transfer), or stored-value account payments, and spending limitations.

A pre-paid method is provided that can include basically the same features of the post-paid method; however, instead of an MRC for the base service (including the unlimited services), the service can be paid by deducting account charges from a pre-paid money pool that can be exhausted (or not) outside of a typical monthly cycle. In this model, the unlimited/included services can be deducted by a daily recurring charge (DRC) instead of an MRC.

In still another aspect of the invention, special treatment is imposed for suspension and resumption of a service. In the pre-paid model, for example, suspension and interruption can be processed to allow both more aggressive collection, and less aggressive number recycling.

In another aspect thereof, certain VAPs of IM services, e-mail services, and other content and services, can be included in the pricing structure/business model. VAPs can receive remittance for some portion of the MRC or DRC for allowing access to the portal services. Those services that normally require a premium charge or payment can be provided to the limited use wireless device without such a premium charge, or with that premium charge included or rolled into the carrier remittance.

The business model can include dependencies on one or more of the following system requirements. For example, a method of charging a DRC (“daily dinger”) which may be external to the normal billing/rating system is provided. A method of limiting access to one or more bundled services that are included in a basic plan or add-on service is provided. Moreover, a method of differentiating access between unlimited/included access and other billing models (per-use, volume based) is provided.

In yet another aspect of the invention, there is provided a method of reliably determining that the device accessing the service(s) is, in fact, a device that supports the methods of and limitations that can be imposed by the business model.

In another aspect thereof, the model provides the capability to the user to view and make payments online, and via the wireless device. Flexible payments options are also provided, e.g., debit card, credit card, savings and checking accounts, gift cards, and Internet-based payment providers. The user is allowed to switch payment methods using the device. Unlimited and limited data pricing plans are provided. The user can also pay by telephone.

In still another aspect of the invention, the model includes a support component that facilitates easy access to offline and online support sources. The user can access support on a 24/7 basis. The user can be routed to more sophisticated support information according to the complexity of the problem, for example, to a live support messaging service interface.

To the accomplishment of the foregoing and related ends, certain illustrative aspects of the invention are described herein in connection with the following description and the annexed drawings. These aspects are indicative, however, of but a few of the various ways in which the principles of the invention may be employed and the invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a dedicated wireless device business model of a wireless provider in accordance with the invention.

FIG. 2 illustrates a flowchart of one methodology of a business model in accordance with the invention.

FIGS. 3A and 3B illustrate one methodology for a post-paid user account in accordance with the invention.

FIGS. 4A and 4B illustrate one methodology for a pre-paid user account in accordance with the invention.

FIG. 5 illustrates one methodology of processing service suspension and resumption under the post-paid payment plan in accordance with the invention.

FIG. 6 illustrates one methodology of processing service suspension and resumption under the pre-paid payment plan in accordance with the invention.

FIG. 7 illustrates a methodology of processing additional VAPs in accordance with the invention.

FIG. 8 illustrates a methodology of processing user activities described as outside the subscriber agreement, in accordance with the invention.

FIG. 9 illustrates a methodology associated with activating a dedicated wireless device using the business model of the invention.

FIG. 10 illustrates a methodology of the invention that determines if the accessing device is supported by the all or part of the provider services.

FIG. 11 illustrates a methodology of the business model for limiting service access to subscribed services in accordance with the invention.

FIG. 12 illustrates a methodology of account analysis and user behavior that can be employed in the business model of the invention.

FIG. 13 illustrates a methodology of the business model for differentiating access between limited and unlimited access and billing models in accordance with the invention.

FIG. 14 illustrates a block diagram of a system that includes the business model of the invention to provide at least services and support to a dedicated wireless device.

FIG. 15 illustrates a block diagram of a computer operable to execute the disclosed business model architecture.

FIG. 16 illustrates a schematic block diagram of an exemplary computing environment that can accommodate the business model in accordance with the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running in a mobile computing device and the mobile computing device can be a component. One or more components may reside within a process and/or thread of execution and a component may be localized on one computer- and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

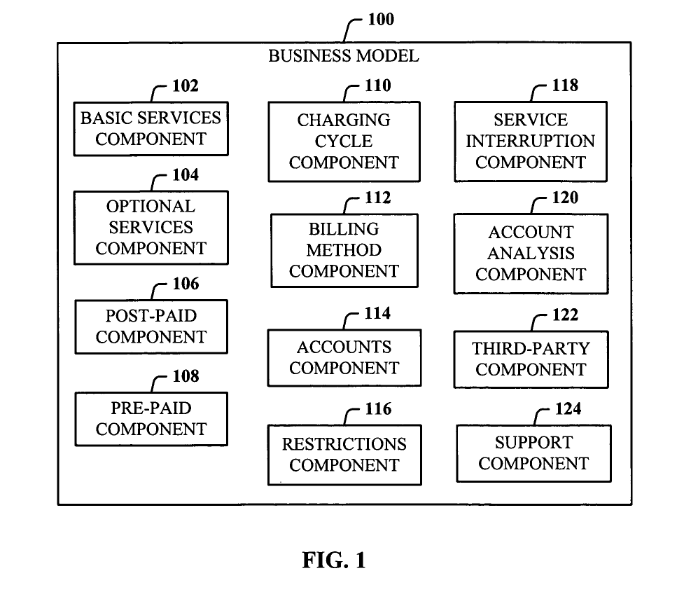

Referring now to FIG. 1, there is illustrated a dedicated wireless device business model 100 of a wireless provider in accordance with the invention. The model 100 includes a number of components that facilitate services, account management, and payment processing. A basic services component 102 provides basic services that each customer (hereinafter, also referred to as a subscriber or user) will receive at a minimum when subscribing to the provider system. By way of example, but not by limitation, this can include domestic peer-to-peer mobile-originated (MO) and mobile-terminated (MT) text messaging, instant messaging (IM) through a native IM client, e-mail account access to user e-mail accounts, and access to a value-added portal (VAP), or third-party provider of other supported services.

In support of extra services that can be purchased, an optional services component 104 provides to the user the capability upgrade basic services and/or add-on services supported by the wireless device. For example, the domestic messaging service can be provided on a limited usage basis as a basic service, but unlimited usage can be provided as an optional upgrade service for an extra fee. An add-on service can be voice, for example, that allows a messaging device to now process voice signals for an extra fee.

Other add-on services can include MMS (Multimedia Message Service) support, polyphonic ring tones, camera support, preloaded or later downloaded games, push e-mail support, attachments support, and location enabled presence support. Note that any of these can be shifted to basic services at no cost to the user. Support for international mobile-originated (MO) SMS (Short Message Service) messages can be purchased for an extra fee. Other services can be selected according to the particular implementation at an additional recurring charge (e.g., daily, weekly, monthly), per-use, or volume-based pricing separate and independent from other recurring charges.

A post-paid component 106 of the business model 100 enables subscriber billing on a post-paid basis. Similarly, a pre-paid component 108 enables subscriber billing on a pre-paid basis. When using the pre-paid plan, offerings can be provided without contract, since the risk is reduced by the available subscriber funds.

A charging cycle component 110 facilitates the charging of fees according to, for example, subscriber usage and selected services. For example, if the subscriber usage is outside of the subscribed services, a charge can be imposed against this outside usage. Similarly, if the subscriber account is based on basic services, yet usage exceeds a service that is limited, the user can be charged a fee according to this excess usage, and a corresponding charging cycle can be imposed on this excess usage. For example, an added charging cycle can be imposed on this account for the excess usage such that as long as the account is over the basic service limit, a daily charge is imposed, in addition to a monthly charge for the basic services. Thus, charging cycles such as a monthly recurring charge or a daily recurring charge, for example, can be imposed according to account criteria, the user, volume, monthly usage, services used, and so on.

A billing method component 112 of the business model 100 facilitates the type of payment mechanism, for example. The user can option to make payments by many conventional manual and electronic means, for example, electronic funds transfer (EFT), credit card, debit card, stored-value account payment, internet-based payment mechanisms, and person checks can be employed to facilitate payment.

An accounts component 114 is provided to store all user account information including username, password, device information, manufacturer device specifications, billing information, subscribed services, etc., that can be accessed to enable the business model 100 of the invention with a dedicated wireless device. The accounts component 114 can also link accounts between a parent account and a child account to support parental supervision over the child account, for example.

The accounts component 114 facilitates reporting to the portal providers (e.g., AOL, MSN, Yahoo!, and an e-mail provider) the total number of customers that are signed up for IM or e-mail access with their device, and on a specific day(s). The IM portals can be paid a certain dollar amount per user per month, for example. This can be computed by taking a snapshot of the portal activities of a single day and adding up the number of users that are subscribed to that specific provider. Another implementation takes two snapshots of two different days in a given month and averages the total number of users that are subscribed to that specific provider.

General usage data needed that can be communicated includes gross account and services adds (daily and monthly), rate plans (daily and monthly), IM portals (daily and monthly), postpaid accounts versus credit cards (daily and monthly), and the chum (daily and monthly). The time periods are merely examples, and can be adjusted as desired.

IM and e-mail usage information communicated can include how many messages are transmitted during an IM session (MT and MO), duration of an average IM session per IM portal, the peak time of IM session per IM portal, and the average number of e-mails per day per IM portal.

SMS usage information that can be communicated includes the total number of SMS messages (per day and per month), the number of MT SMS messages (per day and per month), the number of MO SMS messages (per day and per month), the number of International MT SMS messages (per day and per month), the number of International MO SMS messages (per day and per month), the number of Premium MT SMS messages (per day and per month), the number of Premium MO SMS messages (per day and per month), and the average number of e-mails per day per IM portal. Note that the time periods are adjustable according to the particular application (e.g., per week, per two weeks)

A restrictions component 116 includes limitations or restrictions that can be placed on the account based on account history information, current user behavior, subscribed services, services that can or cannot be employed according to the particular user device, and so on. This can include spending limitations. For example, if the user account is limited to a monthly recurring charge, when the usage exceeds the expected payment, the service can be limited or disabled until the next payment cycle. This can also include limiting access to services that are part of the existing subscriber plan, and/or differentiating access between unlimited included access and other billing models (per-use, volume-based).

A service interruption component 118 facilitates the processing of suspensions in service and resumption thereof caused by the user exceeding account limitations, subscriber payment problems, service interruptions caused by the provider, internal/external network disruptions, etc.

An account analysis component 120 analyzes account parameters such as usage, to implement added services or a reduction in services, when such analysis option is selected by the user for account management. For example, if the user subscribes to basic services that provide limited usage, but over time increases account usage that is normally associated with unlimited usage, the analysis component 120 can facilitate triggering a notification to the user to reduce usage to correspondingly reduce the excessive fees paid for exceeding the subscribed plan, or upgrade to different plan or service(s) to that provides a more economic benefit that covers the excessive usage and reduces the excessive fees. The user can then choose the upgraded plan or reduce usage, for example.

Such analysis can be implemented using artificial intelligence (AI) as part of the analysis component 120 to learn and predict according input data, such as to subscriber account and usage data. In another example, if the usage as analyzed over a period of three weeks is predicted to exceed the allotted monthly usage amount, the user can be signaled to this effect such that acknowledgement is required of the notification. In still another example, if the device has been stolen and the provider has yet to be notified of the loss, and the usage has increased dramatically in a short period of time, the business model 100 can impose limitations on the account in response to account analysis such that services are severely limited or even disabled until the user acknowledges proper use and authorization of the account.

A third party component 122 facilitates the selection and financial interaction with third party VAPs. For example, where a basic service includes the selection of one VAP, the third party component 122 facilitates the communication of information between the system of the business model 100 and the VAP. When the user chooses to add more VAPs, the third party component 122 facilitates the implementation thereof to the business model 100 and user account, to include financial transactions and enabling signals to allow the user access to the added VAP, for example.

A support component 124 facilitates providing support to a subscriber who chooses to access the support options. The user can obtain basic support such as FAQs, more detailed support from a knowledge database, and live support for more complex issues. The support component 124 facilitates support on a 24/7 basis via the wireless device, telephone support, and/or computer support via a home computer, for example. The support component 124 facilitates activation and provisioning of the device whether purchase is by direct retail (brick and mortar), indirect retail (e.g., mass retailers), direct virtual (from the manufacturer website), or indirect virtual (partnered online retailers). Thus, activation can be at the place of purchase (direct retailer), online (virtual direct and indirect), and over the telephone, for example.

It is to be appreciated that although the components are illustrated as separate components, any number of the components can be combined in any manner desired to facilitate the business model 100. Moreover, the number of components illustrated is not exhaustive in that other components can be added to further facilitate dedicated wireless device servicing in accordance with the invention. Thus, a basic services offer can be configured to include parts of the other components or one or more of the other component, entirely. In one combined services implementation, a specific offer plan comprises the following: a post-payment plan that is a single MRC to include some or all of the following other services and/or components: unlimited domestic text messaging; unlimited 11 through a native 11 client; unlimited e-mail to pre-existing Internet-accessible e-mail accounts (e.g., POP3) with no attachments; access to one VAP 3^{rd} party portal provider; access to additional VAPs for an additional monthly fee, a voice service “bolt-on” at standard voice rates; international MO SMS messages at an additional fee; additional services at additional MRC, per-use, or volume-based pricing separate and independent of other MRCs; automatic recurring credit card, EFT, or stored-value account payments; and spending limitations.

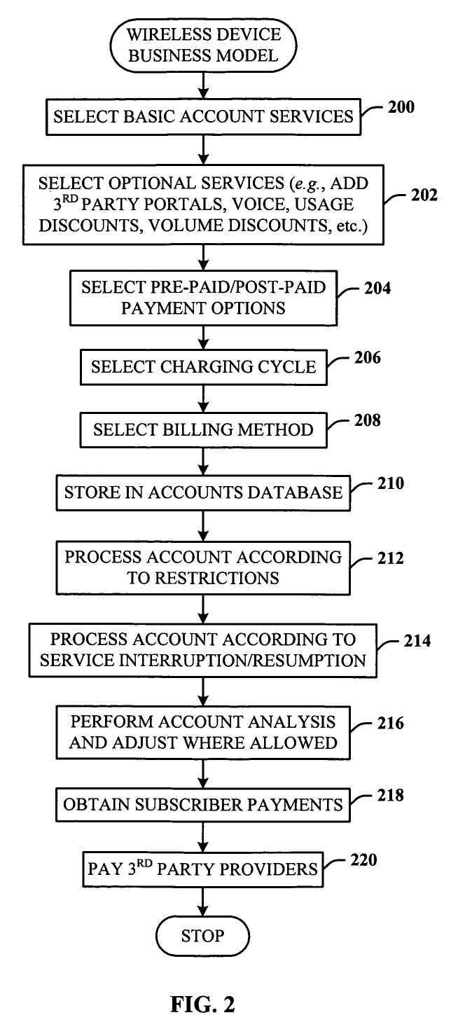

Referring now to FIG. 2, there is illustrated a methodology of a business model in accordance with the invention. While, for purposes of simplicity of explanation, the one or more methodologies shown herein, e.g., in the form of a flow chart, are shown and described as a series of acts, it is to be understood and appreciated that the invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 200, basic services are selected by the subscriber. At 202, optional services can be selected by the user, e.g., third party portals, voice, usage discounts, volume discounts, and international communications services. At 204, the user can select post-paid or pre-paid payment options. At 206, the charging cycle can be selected, for example, daily in a pre-paid scenario, and monthly in a post-paid scenario. At 208, the billing method can be selected, e.g., by EFT. At 210, the account information input by the user is stored in an account database. This includes all user related information, e.g., user credentials, personal information, subscribed services and add-ons, device information associated with the account, and so on.

At 212, the account is processed according to restrictions, which can include restrictions developed from user credit, past usage, expected usage, spending limitations, and so on. At 214, the account can be processed according to service suspensions and resumptions. For example, if the service suspension is user-generated by, for example, payment problems, a penalty charge can be imposed to resume the service. At 216, the model can facilitate account analysis and suggest different service structures, payment methods, charging cycles, etc., for the user account to provide improved management of user and provider costs, reduced exposure to the provider based on the user, reduced exposure to the user if the account and/or associated device is compromised, and improved servicing of the user account, for example.

At 218, payment can be obtained according to the selected billing method, for example, EFT, stored-value account, and credit card. At 220, third party providers are then paid according to the services provided to the user.

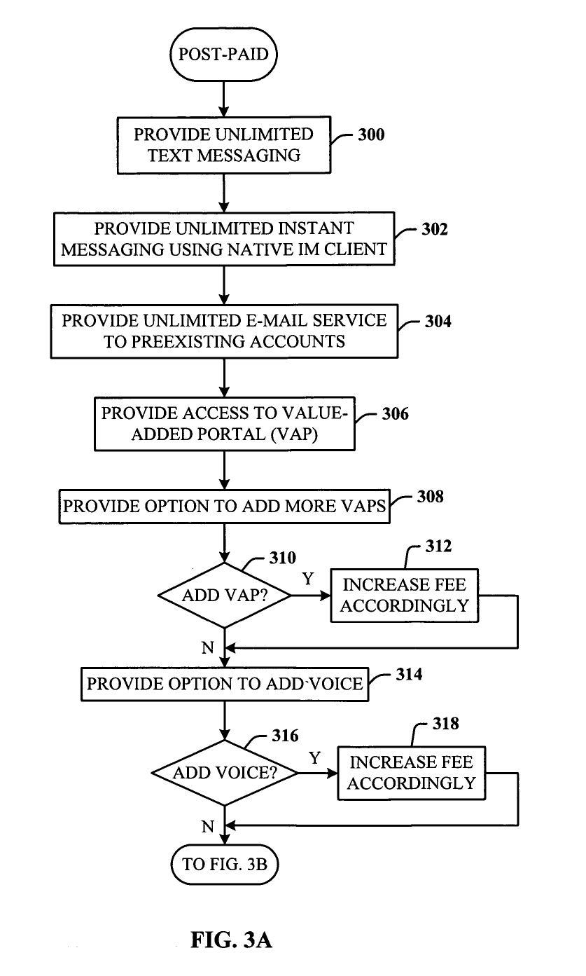

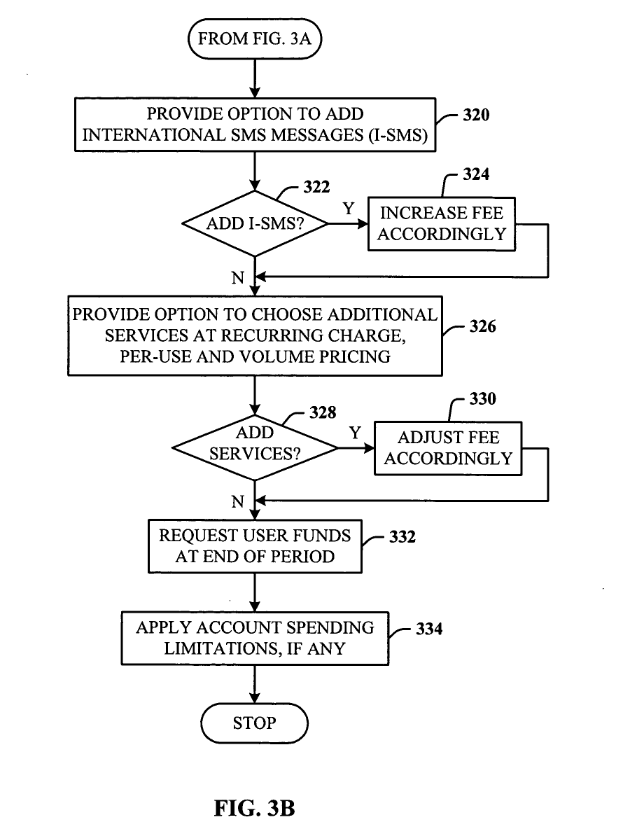

Referring now to FIGS. 3A and 3B, there is illustrated one methodology of the business model for a post-paid user account in accordance with the invention. At 300, unlimited text messaging is provided from any or all of the portal providers. At 302, unlimited IM is provided using the native IM client. At 304, unlimited e-mail service is provided to preexisting user e-mail accounts. At 306, the account is configured to provide for one VAP. If the user has more than one, the user will be prompted to choose only one. At 308, the business model provides the option under the post-paid plan to add one or more VAPs. At 310, the system determines if the user has decided to add more VAPs. If so, flow is to 312 where an associated fee is added to the final charges, and flow is to 314 to present an option to add another service to the account, e.g., voice services.

If no further VAP is selected, flow is to 314. If, at 316, the user chooses to add voice, flow is to 318 to increase the fee accordingly, and then to FIG. 3B, where an option is provided to add international SMS messaging (e.g., MO and/or MT). If the user does not choose to add voice, flow is from 316 to 320. If the user chooses international SMS messaging, flow is from 322 to 324 to increase the fees accordingly, and then to 326 for the next option. If the user does not choose international SMS, flow is to 326 where the option to choose additional services at the same or different pricing scheme is provided, e.g., the same or different recurring charge, per-use basis, or volume pricing.

If, at 328, the user chooses to add the services according to the same or different charging scheme, flow is to 330 to adjust the fees accordingly, and then to 332 to request user funds for the total package at the end of the post-payment period. For example, the period can be thirty days, such that at the end of the thirty-day period, the funds are obtained from the user. If the user does not choose to add services, flow is from 328 to 332 to request the finds. At 334, account spending limitations are applied. This can include limitations based on user credit, and device limitations that the user has specified, for example. It is also to be appreciated that the limitations component simply applies a null value, which means that no limitations are applied.

It is noted that the selection process for this account can be accomplished via the dedicated wireless device. For example, as part of provisioning and activation, the device provides a reduced functionality initially to allow the user to make the account selections. Thus, the device communicates with the provider systems via an activation wizard to allow the user to setup the account according to all desired selections. Account activation can also be facilitated via a global communications network such as the Internet, or by telephone to a customer service representative.

The business method of the subject invention facilitates a grab-and-go proficiency whereby the user can activate the device out of the box without a contract and without contacting a customer support location. In one implementation of account activation, the activation wizard prompts the user for personal information sufficient to allow a live credit check to be made at that time such that in response to results of the credit check, certain services will be presented or not presented for selection by the user. For example, if the result indicates that the user is a credit risk, only limited services options can be present for selection versus unlimited options for a user with a better credit rating.

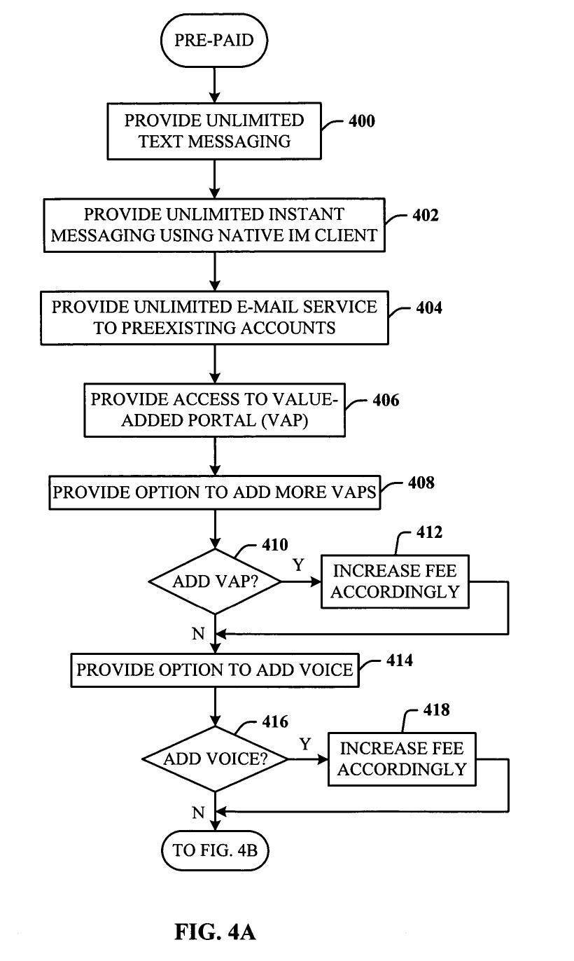

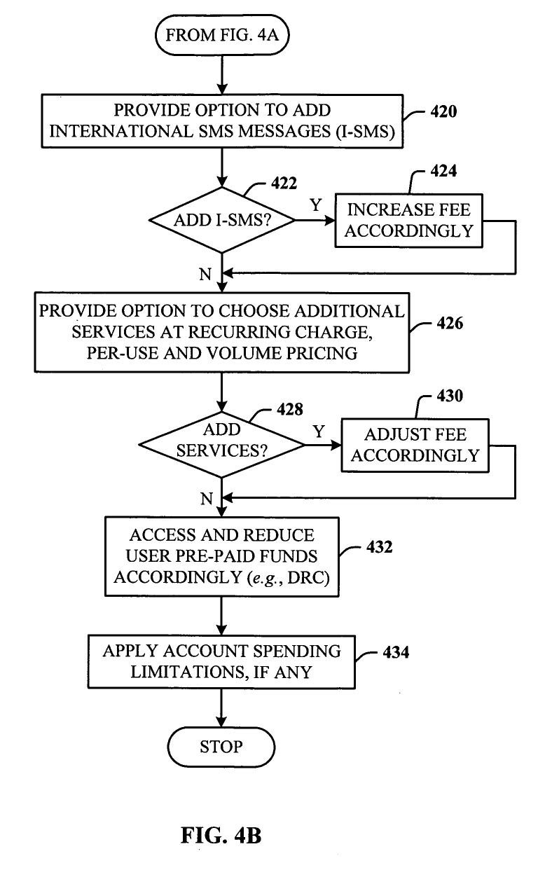

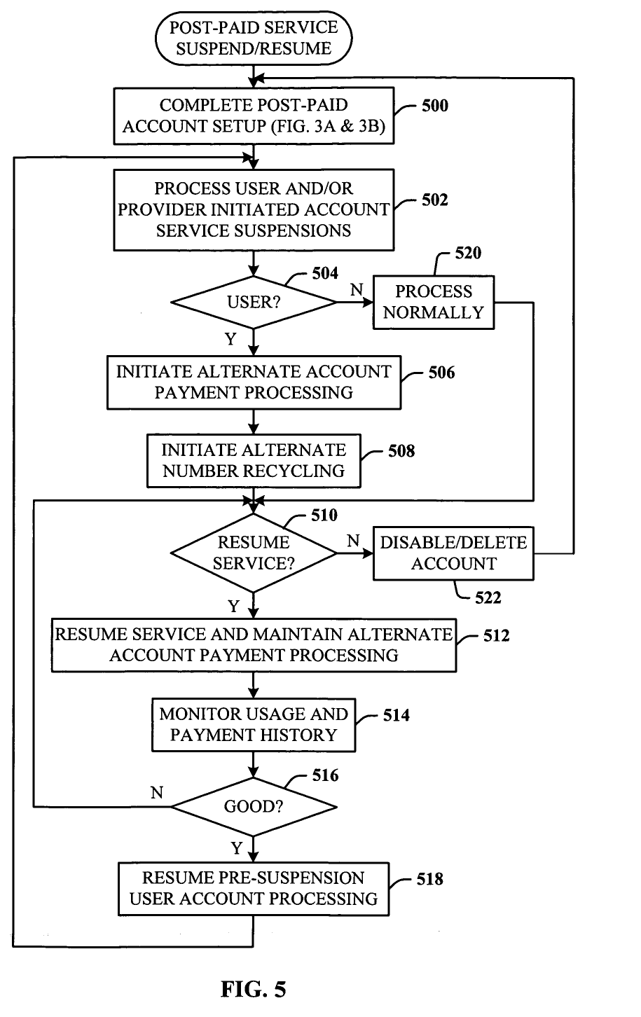

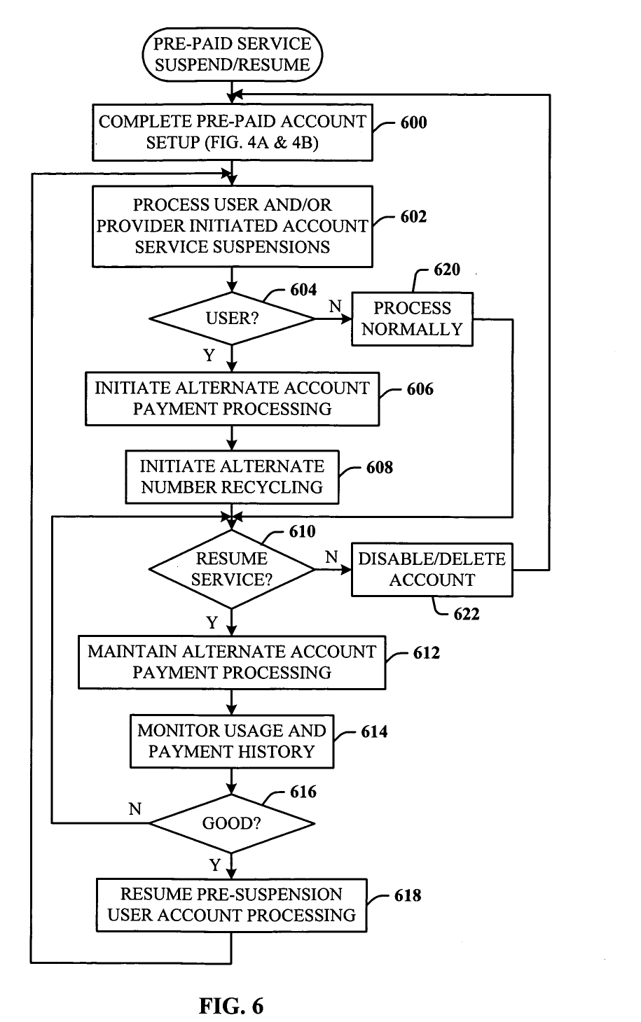

Referring now to FIGS. 4A and 4B, there is illustrated a methodology of a pre-paid user account in accordance with the invention. At 400, unlimited text messaging is provided for any or all of the portal providers. At 402, unlimited IM is provided using the native IM client. At 404, unlimited e-mail service is provided to preexisting user e-mail accounts. At 406, the account is configured to provide for one VAP. If the user has more than one, the user will be prompted to choose only one. At 408, the business model provides the option to add one or more VAPs, e.g., under the pre-paid plan. At 410, the system determines if the user has decided to add more VAPs. If so, flow is to 412 where an associated fee is added to the final charges, and flow is to 414 to present an option to add another service to the account, e.g., voice services.

If no further VAP is selected, flow is to 414. If, at 416, the user chooses to add voice, flow is to 418 to increase the fee accordingly, and then to FIG. 4B, where an option is provided to add international SMS messaging (e.g., MO and/or MT). If the user does not choose to add voice, flow is to 420. If the user chooses international SMS messaging, flow is from 422 to 424 to increase the fees accordingly, and then to 426 for the next option. If the user does not choose international SMS, flow is from 422 to 426 where the option to choose additional services at the same or different pricing scheme is provided, e.g., the same or different recurring charge, per-use basis, or volume pricing. If, at 428, the user chooses to add the services according to the same or different charging scheme, flow is to 430 to adjust the fees accordingly, and then to 432 to access and reduce user pre-paid finds accordingly.

When using a pre-paid funding plan, different charging schemes can be employed. For example, the system can setup to use a daily recurring charge, such that charges are satisfied against the user funds on a daily basis based on actual daily usage, or based on an average daily usage over a thirty-day period. If the user does not choose to add services, flow is from 428 to 432. At 434, account spending limitations, if any, are applied. This can include limitations based on user credit, and device limitations that the user has specified, for example.

As before, with the post-paid structure, it is noted that the selection process for this account can be accomplished via the dedicated wireless device or via a computer or by telephone. Thus, the user can communicate with the provider systems by many means to allow the user to setup the account according to all selections made.

Referring now to FIG. 5, there is illustrated a methodology of the business model for processing service suspension and resumption under the post-paid payment plan in accordance with the invention. At 500, the user completes the post-paid account creation process according to the methodology of FIGS. 3A and 3B. At 502, the system processes a user and/or provider initiated account service suspension. At 504, if it is a user initiated suspension, because of a late payment, for example, flow is to 506 to initiate alternative account payment processing. This can include an aggressive collections method that executes, for example, a secondary method of payment processing.

In one example, if the user initially stipulated that primary payment is by EFT from a checking account, and the secondary payment mechanism is by credit card, the system can be configured to automatically extract payment against the secondary source when the primary source fails. Such a shift in payment source can include discontinuing service to the user until the user acknowledges the payment problem and authorizes resumption of service against the primary or secondary payment source. Surcharges can be imposed against the secondary source if it requires added expense to the provider while the secondary payment source is being exercised.

At 508, alternate number recycling can be implemented. For example, a more aggressive number recycling plan can be initiated when the service is suspended without the possibly of service resumption. When the suspension occurs, the severity of the suspension can be ascertained, and which further can be used to determine the aggressiveness of the number recycling method employed.

At 510, it is determined whether to resume service. If yes, flow is to 512 where service is resumed, and the alternative account payment method can be maintained. The alternative payment plan can be used until the user is allowed to change back to the primary plan, or other factors are considered that automatically allow payment from the primary payment method. For example, at 514, user account payment history and usage can be analyzed to determine when the user can be allowed to switch payment sources. If according to predetermined “good standing” criteria, at 516, the system can determine that user account information now places the user in good standing, service can be resumed automatically with payment reinitiated from the primary payment source, and with acknowledgement from the user. All services can then be resumed according to the pre-suspension status, as indicated at 518. Flow is then back to 502 to continue monitoring and processing account suspensions/resumptions.

At 504, if the account suspension was the fault of the provider, at 520, the account can be processed normally, with flow to 510 to then resume service automatically. For example, if the account was suspended due to a provider system failure, service could be automatically resumed to the user account. It is to be appreciated that where service suspension is the fault of the provider, certain benefits or bonuses can be added to the user account as compensation for the suspension. For example, if the suspension was due to no fault of the user, the provider can configure the system to automatically add a month of basic services at no charge to the user. In such a scenario, a notification can be sent to the wireless device by way of any type of message (e.g., e-mail, IM and/or SMS) to inform the user of the free month of usage. The user account is then automatically updated to reflect the change.

If at 510, the account suspension was due to user actions that cannot or will not be corrected, flow is to 522 to disable or delete the account. Flow is then back to 500 to process a new account. However, where the account was disabled for a period of time until the user is back in good standing, the account can be re-enabled without requiring a new account creation.

At 516, if the user account is not yet in good standing, flow is back to 510 to determine whether to resume service based on the alternate payment method. If this payment method eventually fails, the user account can then be disabled and/or deleted accordingly, at 522.

Referring now to FIG. 6, there is illustrated a methodology of the business model for processing service suspension and resumption under the pre-paid payment plan in accordance with the invention. At 600, the user completes the pre-paid account creation process according to the methodology of FIGS. 4A and 4B. At 602, the system processes a user and/or provider initiated account service suspension. At 604, if it is a user initiated suspension, flow is to 606 to initiate alternative account payment processing. This can include an aggressive collections method that executes, for example, a secondary method of payment processing, where daily charges (instead of weekly or monthly) are obtained from the pre-paid money pool established by the user.

In another example, this can include the same payment options described with respect to the post-paid service interruption methodology. For example, if the user initially stipulated that primary payment is by EFT from a checking account, and the secondary payment mechanism is by credit card, the system can be configured to automatically extract payment against the secondary source when the primary source fails. Such a shift in payment source can include discontinuing service to the user until the user acknowledges the payment problem and authorizes resumption of service against the primary or secondary payment source. Surcharges can be imposed against the secondary source if it requires added expense to the provider while the secondary payment source is being exercised.

At 608, alternate number recycling can be implemented. For example, a less aggressive number recycling plan can be initiated when the service is suspended with the possibly of service resumption. When the suspension occurs, the severity of the suspension can be ascertained, and which further can be used to determine the aggressiveness of the number recycling method employed.

At 610, it is determined whether to resume service. If yes, flow is to 612 where service is resumed, and the alternative account payment method can be maintained. The alternative payment plan can be used until the user is allowed to change back to the primary plan, or other factors are considered that automatically allow payment from the primary payment method. For example, at 614, user account payment history and usage can be analyzed to determine when the user can be allowed to switch back to the relaxed charging cycle of one month, for example. If according to predetermined “good standing” criteria, at 616, the system can determine that user account information now places the user in good standing, service can be resumed automatically with payment reinitiated according to the initial payment scheme, and with acknowledgement from the user. All services can then be resumed according to the pre-suspension status, as indicated at 618. Flow is then back to 602 to continue monitoring and processing account suspensions/resumptions.

At 604, if the account suspension was the fault of the provider, at 620, the account can be processed normally, with flow to 610 to then resume service automatically. For example, if the account was suspended due to a provider system failure, service could be automatically resumed to the user account. It is to be appreciated that where service suspension is the fault of the provider, certain benefits or bonuses can be added to the user account as compensation for the suspension. For example, if the suspension was due to no fault of the user, the provider can configure the system to automatically add a month of basic services at no charge to the user. In such a scenario, a notification can be sent to the wireless device by way of any type of message (e.g., e-mail, IM and/or SMS) to inform the user of the free month of usage. The user account is then automatically updated to reflect the change.

If, at 610, the account suspension was due to user actions that cannot or will not be corrected, flow is to 622 to disable or delete the account. Flow is then back to 600 to process a new account. However, where the account was disabled for a period of time until the user is back in good standing, the account can be re-enabled without requiring a new account creation.

At 616, if the user account is not yet in good standing, flow is back to 610 to determine whether to resume service based on the alternate payment method. If this payment method eventually fails, the user account can then be disabled and/or deleted accordingly, at 622.

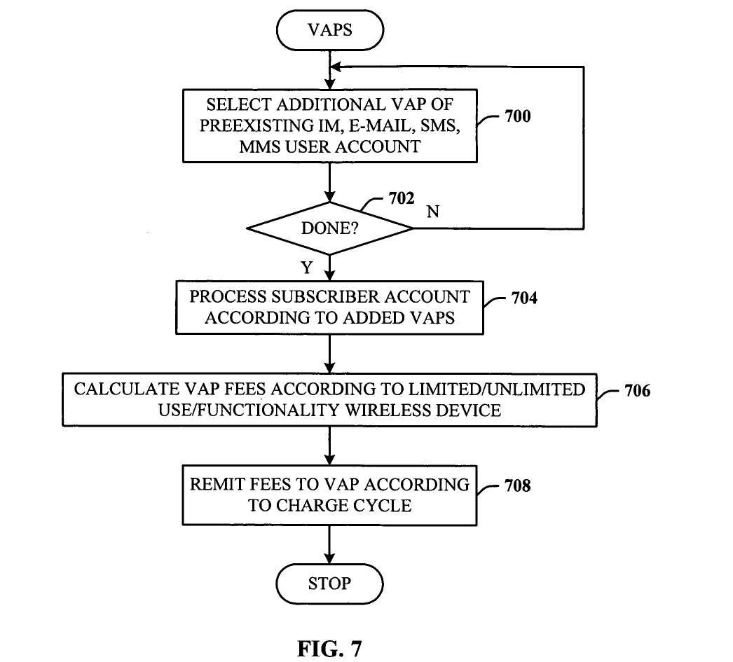

Referring now to FIG. 7, there is illustrated a methodology of the business model for processing additional VAPs in accordance with the invention. Certain third-party portal providers of, for example, IM services, e-mail services, SMS services, or other content or services (e.g., MMS), can be included in the pricing structure/business model. VAPs can receive remittance for some portion of the monthly or daily recurring charge for allowing access to their portal services. Those services which normally require a premium charge or payment may be provided to the limited-use wireless device without such a premium charge, or with that premium charge included or rolled into the carrier remittance.

At 700, the user is allowed to select one or more additional VAPs based on preexisting user VAP accounts, which VAP accounts can include IM, e-mail, and SMS accounts. In another implementation, the preexisting VAP accounts can include an MMS account. At 702, if the user has not finished selecting VAP accounts, flow is back to 700 to make another selection. Note that the activation wizard can require that the user complete activation of one VAP service before setting up another VAP service on the account.

The process for determining how many accounts to be included can be determined in a number of different ways. For example, the user can decide which of the preexisting accounts to be added in accordance to limits imposed by the business model. In another implementation, the number of accounts is determined by the system such that if the system imposes a rule that indicates a total of no more than three accounts each of which must be different, and the user has two of the same type of accounts, e.g., two e-mail accounts, the system will notify the user that only one of two e-mail accounts can be selected.

The system can also impose a restriction on accounts selected according to account history information obtained from a participating provider. For example, if after subscribing to the disclosed system, and during the account creation process, it is determined in communication with a VAP that the user had previously defaulted on an account therewith, this information can be communicated such that this system will not allow access to the VAP provider services. The user would then be notified that selection of this VAP account is not allowed.

Once the assortment of VAP accounts have been selected and verified, the subscriber account is processed according to the selected additional providers, as indicated at 704. In one implementation, the wizard takes all the user information at once for all VAPs, and then communicates the user information separately to each VAP. In another implementation, the user must enter account information for each VAP service separately. At 706, additional fees are calculated based on the additional VAPs selected for the user account. Moreover, the fees can be based upon limited and unlimited use of the services of the subscriber account and, limited and unlimited functionality of the user wireless device associated with the account. At 708, fees for the selected additional VAP services are then remitted according to the charge cycle.

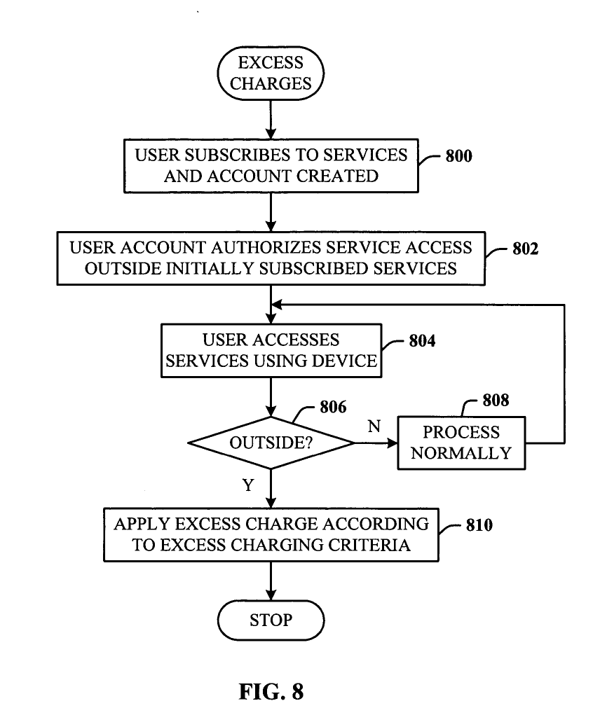

Referring now to FIG. 8, there is illustrated a methodology of processing user activities described as outside the subscriber agreement, in accordance with the invention. This can include a process of imposing a daily recurring charge (called a “daily dinger”) that can be external to the normal billing/rating system. At 800, the user subscribes to services and the user account is created. At 802, the user account is one that the provider authorizes service access that is considered outside of the subscriber agreement. This option can be supported by an additional fee such that if the user exceeds the services agreement, the user account is not suspended, but operates according to the selected services but at a surcharge until the next payment period. For example, if the user is currently under a subscriber agreement that stipulates limited access to a provided e-mail service of no more than 1,000 messages in a one month period, but the number of messages exceeds 1,000, the user account is surcharged with additional fees until the beginning of the next month when the message count is reset.

By way of another example, but not by limitation, the user account agreement indicates that the user desires to operate under basic services, only. Yet during account creation, the system provides that the user can access additional enhanced (or non-basic) services at anytime with acknowledgement that the user account will be automatically upgraded to the service, if used. Many other variations of processing account excesses or exceptions are within contemplation of the subject business model.

Similarly, if the user selects a more enhanced plan, yet usage over a period of time is analyzed to indicate that the account is underutilized, the model can suggest for confirmation a less expensive plan that meets the user's requirements. This can be made a selectable account option that automatically enables the more economical plan without user intervention, but only notification that the plan has been changed.

Thus, at 804, the user accesses a service. At 806, the system determines if the service selected via the wireless device is considered outside the normal subscribed agreement. If no, flow is to 808 to process the account normally. Flow is then back to 804. However, if at 806, the service is determined to be outside the standard subscriber agreement, flow is to 810 to apply excess charges against the user account according to excess charging criteria. In another implementation, the user is only charged for the excess service, and not upgraded to the initially unselected service.

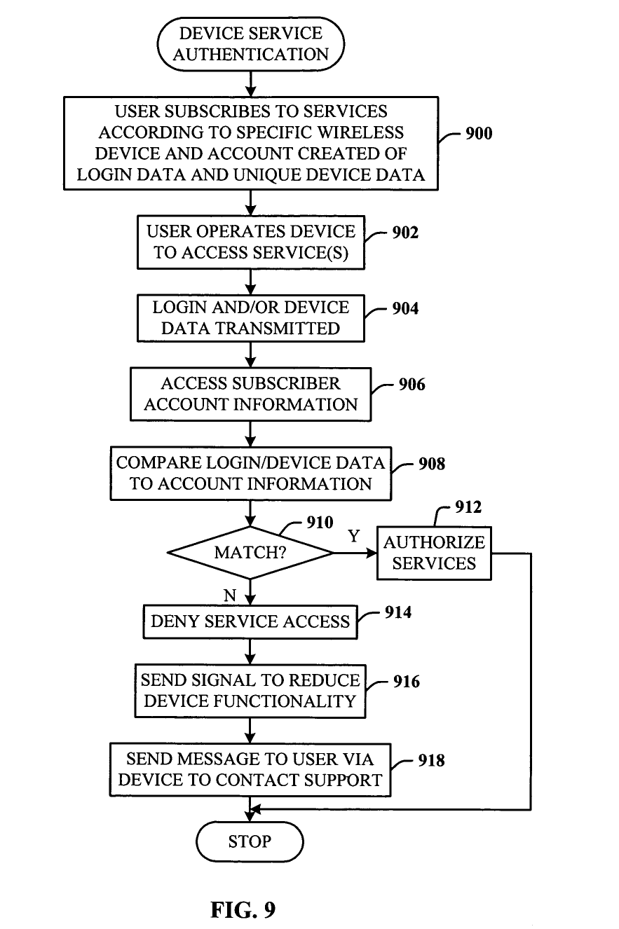

Referring now to FIG. 9, there is illustrated a methodology of the business model associated with activating a dedicated wireless device using the business model of the invention. At 900, the user subscribes to services that are supported by a specific wireless device and the account is created of at least login data and unique device data. At 902, the user operates the device to access one or more services. At 904, the user is required to login to the device. The user login (e.g., username and password) and a unique device identifier can be considered the device credentials. The login process can include caching the credentials such that account login is automatic, and hence, transparent to the user. In any case, the credentials are transmitted to the provider system for authentication processing. At 906, the user account is accessed according to the all or part of the credentials. At 908, all or part of the credentials is used to compare to the user account information. If, at 910, there is a successful match, the subscribed services are authorized to the device.

However, if at 910, all or part of the credentials do not match the user account information, flow is to 914 to deny access to the provider services by the device. At 916, as a precautionary or security measure, the provider can send a signal to the device to reduce device functionality. This reduced functionality can include allowing only basic communications to resolve the problem. For example, communications could be restricted only to a support connection. At the same time, the user account could be locked to prevent further funds processing and other account accessing for personal or confidential information, for example.

In another example, the device communications are totally disabled. When the user power up the device, the only information displayed is that the user needs to contact customer support.

In yet another example, a message is sent to one or more of the user accounts by the provider that indicates that the account is being disabled, and the reasons for doing so. This information can also be communicated to a cell phone of the user or a home telephone number of the user as provided during account creation.

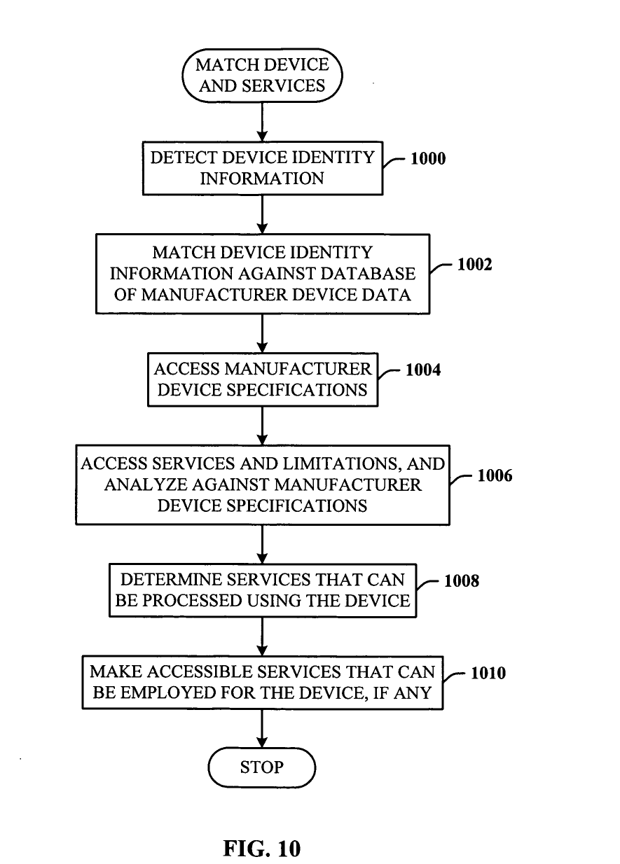

Referring now to FIG. 10, there is illustrated a methodology of the business model of the invention that determines if the accessing device is supported by all or part of the provider services. At 1000, the device identity information is detected by the provider system. In an always-on communications regime, this device identification process can be performed on a periodic basis as a condition for continued service. For example, the device can be designed to communicate its identity to the provider every ten minutes that it is in use. This could be made to occur transparently to the user. At 1002, the device identity is compared against a manufacturer database of wireless devices and associate specifications data.

At 1004, the device specifications data is accessed. At 1006, the provider services and limitations are accessed and compared with the manufacturer specifications for the device. At 1008, in accordance with the supported device, the provider automatically determines which services will be supported. In response thereto, only the supported services for the given device will then be presented to the user during the activation and provisioning process, as indicated at 1010. The manufacturer specifications for all of its devices can be stored local to the provider, and updated on a regular basis for more ready access when needed by the provider and its subscribers. Alternatively, or in conjunction with the local database, the device information can be accessed by the provider at the manufacturer as a condition of partnership between the two entities.

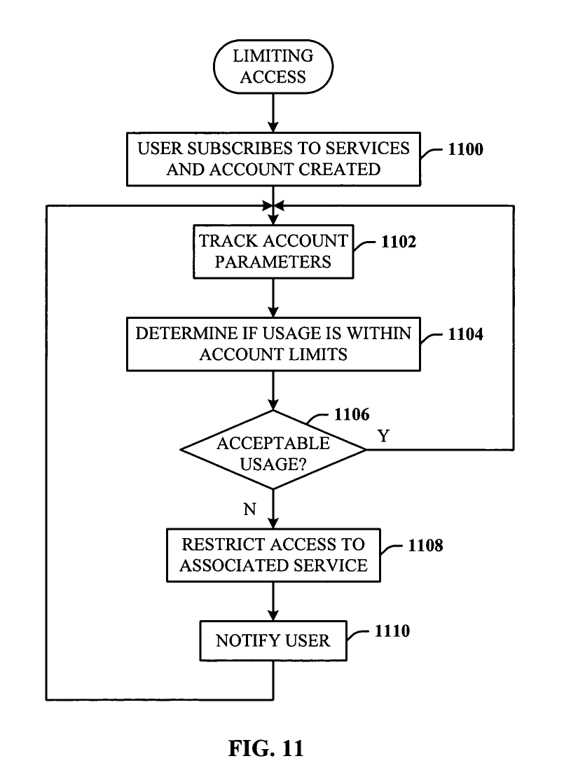

Referring now to FIG. 11, there is illustrated a methodology of the business model for limiting service access to subscribed services in accordance with the invention. At 1100, the user subscribes to services and the user account is created. At 1102, account parameters are tracked. At 1104, the system determines if subscriber usage it within limits placed on one or more account parameters. At 1106, subscriber usage is determined to be within acceptable account limits, flow is back to 1102 to continue tracking and processing the account parameters. If, at 1106, the system determines that a parameter is outside the account limits, flow is to 1108 to restrict access to the associated service. This can include disabling the service with notification to the user, or reducing service functionality to a lower level. At 1110, the provider can signal the user of the reduced service access. Flow is then back to 1102 to continue tracking and processing the account parameters.

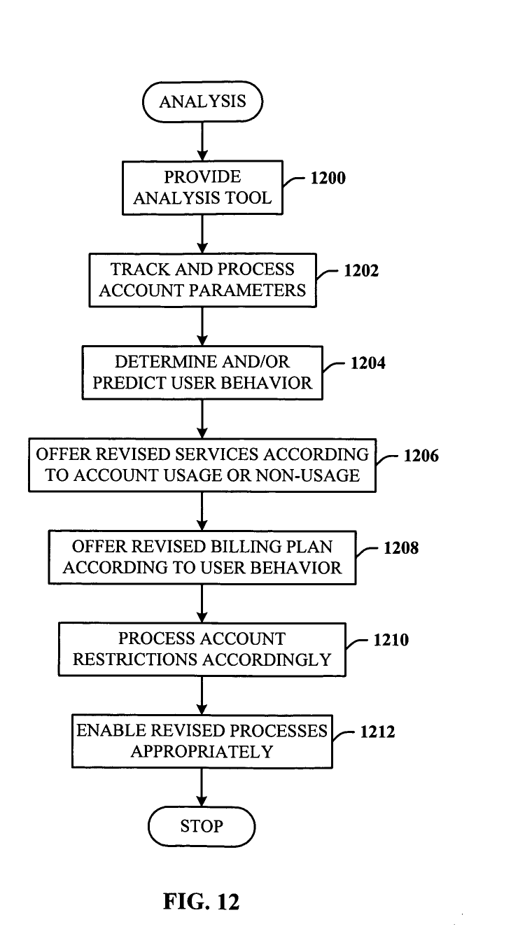

Referring now to FIG. 12, there is illustrated a methodology of account analysis and user behavior that can be employed in the business model of the invention. At 1200, the analysis tool is provided. At 1202, the tool is applied to track and process account information, which can include any system signals and/or data associated with the account, e.g., the number of messages, the types of messages (SMS, e-mail, IM, etc.), the size of the messages (in bytes), the number of times the user logs in to use the account, the time of the communications, and so on. At 1204, the analysis tool processes the account information to generate data that can be used to make decisions and predict behavior, for example.

The analysis tool of the subject invention can employ various artificial intelligence based schemes for carrying out various aspects thereof. For example, a process for determining when a user account exhibits usage behavior beyond the limits of past use can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine is an example of a classifier that can be employed. The machine operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, support vector machines can be configured via a learning or training phase within a classifier constructor and feature selection module. Thus, the classifier(s) can be used to automatically perform a number of functions, including by example but not by limitation to determining according to a predetermined criteria if account usage exceeds limits generated by the user during past use, predicting account usage such that one or more existing services can be automatically upgraded based on actual usage or predicted use, and minimizing risk and exposure to the provider and/or user by enabling or disabling account features according to limits fixed at account creation or limits learned during account usage. These are but a few of the benefits that can be obtained by employing such an analysis tool.

At 1206, as indicated previously, the tool facilitates offering or enabling revised services or account features based on user usage or non-usage. At 1208, the tool facilitates offering or enabling a revised account billing plan based on user behavior or account usage. At 1210, the account restrictions are processed accordingly. At 1212, revised processes are enabled where appropriate. That is, although the user account has exhibited atypical usage behavior, the restrictions or controls can still be prevented from being enabled, if desired, where the behavior does not expose the provider to increased risk. On the other hand, account behavior can be automatically controlled where the activities, as determined by the analysis tool, indicate increased risk and exposure to the provider and provider systems.

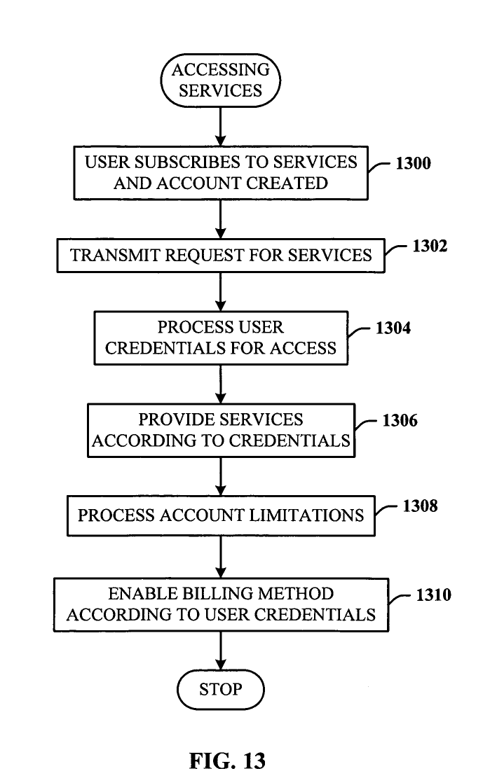

Referring now to FIG. 13, there is illustrated a methodology of the business model for differentiating access between limited and unlimited access and billing models in accordance with the invention. At 1300, a user subscribes to services and the account is created. At 1302, the user logs in to the dedicated wireless device and transmits a request for services. This can be automatic and transparent to the user in that by simply powering up the device, the credentials are transmitted to the provider for authentication, as indicated at 1304, and the subscribed services are automatically processed to, for example, download messages from each of the subscribed user accounts, further indicated at 1306. At 1308, account limitations are processed. At 1310, the user credentials are processed to enable the subscribed services and features of the account. This can include whether the user is allowed limited or unlimited access to one or more portals, and the type of billing method imposed on each service or all services (e.g., per-use, volume based).

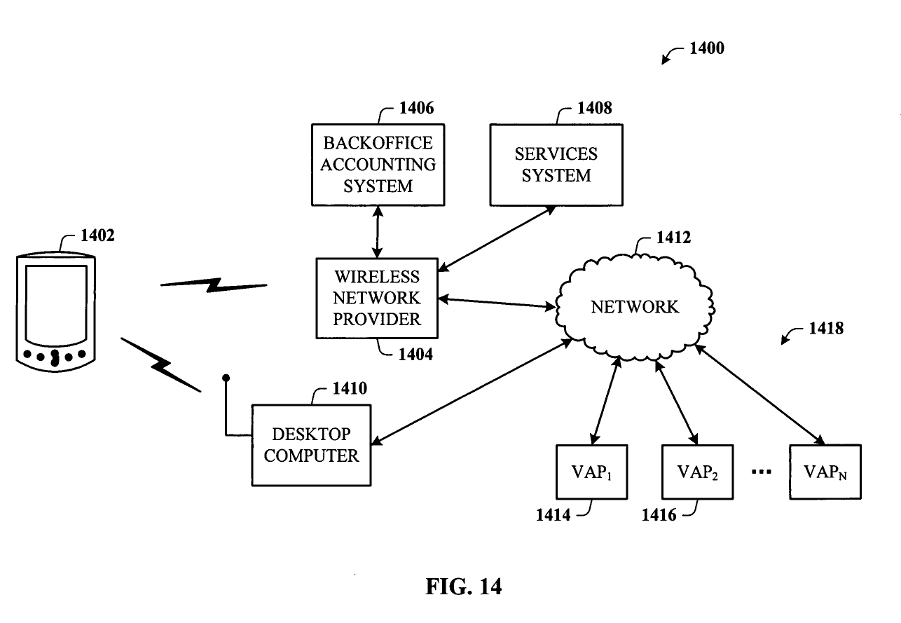

Referring now to FIG. 14, there is illustrated a block diagram of a system 1400 that includes the business model of the invention to provide at least services and support to a dedicated wireless device 1402. A user purchases the device 1402 and is immediately provided the capability to activate the device 1402 wirelessly for use. The user can activate the device 1402 via an activation wizard on the device 1402 that interfaces to a wireless network provider 1404. The activation wizard prompts the user for the required information to create user credentials and a user account that are stored and processed in accordance with the business model of the invention. The wireless network provider 1404 interfaces to a backoffice accounting system 1406 and a services system 1408 that together facilitate the business model. It is to be appreciated that the functionality of the backoffice accounting system 1406 and the services system 1408 can be combined into a single system. Moreover, all functionality of the single system can be combined into the network provider block 1404.

It is further to be appreciated that the components of the business model described in FIG. 1 can be distributed in any manner desired to improve the services and support to the subscriber devices and accounts. For example, the various components of FIG. 1 can be distributed among several servers to provide the bandwidth and speed required to quickly service the user devices. Account information can then be synchronized across the servers during non-peak hours to further support roaming of the devices across geographic distances.

The user can also activate the device 1404 via a desktop computer by logging into a website of the provider 1404, if the provider 1404 and the device manufacturer are the same. Of course, the activation means can be hosted anywhere suitable to provide such functionality. Thus, the user can activate the device 1402 by entering user information and account information via the computer 1410 over the network 1412 to the provider 1404. The user account information is then stored and accessed on the backoffice accounting system 1406.

As indicated hereinabove, the business model allows the user to activate the device 1402 by selecting a basic plan of services, and adding other services for extra fees, for example. Where the device 1402 is supported for such added services, the user can select an additional IM portal that is supported by a first portal provider 1414 (also denoted VAP₁). The model also allows the user to select an additional e-mail portal via a second portal provider 1416 (also denoted VAP₂). Other portal providers can be accessed, for example, up to N providers (denoted VAP_{N}) depending on the user, user account information, and device limitations.

The activation wizard of the device 1402 interfaces to the network provider 1404, which provider 1404 facilitates setting up the portal accounts to the portal providers 1418. Alternatively, the wizard can facilitate partial or full interfacing directly to portal accounts of the portals 1418 as part of the account creation process.

It is to be appreciated that the business model of described herein is not restricted to providing services and support to only a messaging-centric device, but can be employed to provide flexible models in support of any portable wireless device, including by example but not by limitation, a cellular telephone, a personal data assistant (PDA), and a portable computer.

In one supporting implementation of the invention, a parent subscribes to two accounts-one for a child and the other for the parent. The child device allows the parent to stay in contact with the child using any of the messaging portals described herein. The parent can request that the child account be linked with the parent account such that the parent can monitor child usage by receiving notifications if the child “out of bucket”, by deleting unauthorized options selected by the child, cut off service to the child device if the child behavior is irresponsible, and so on.

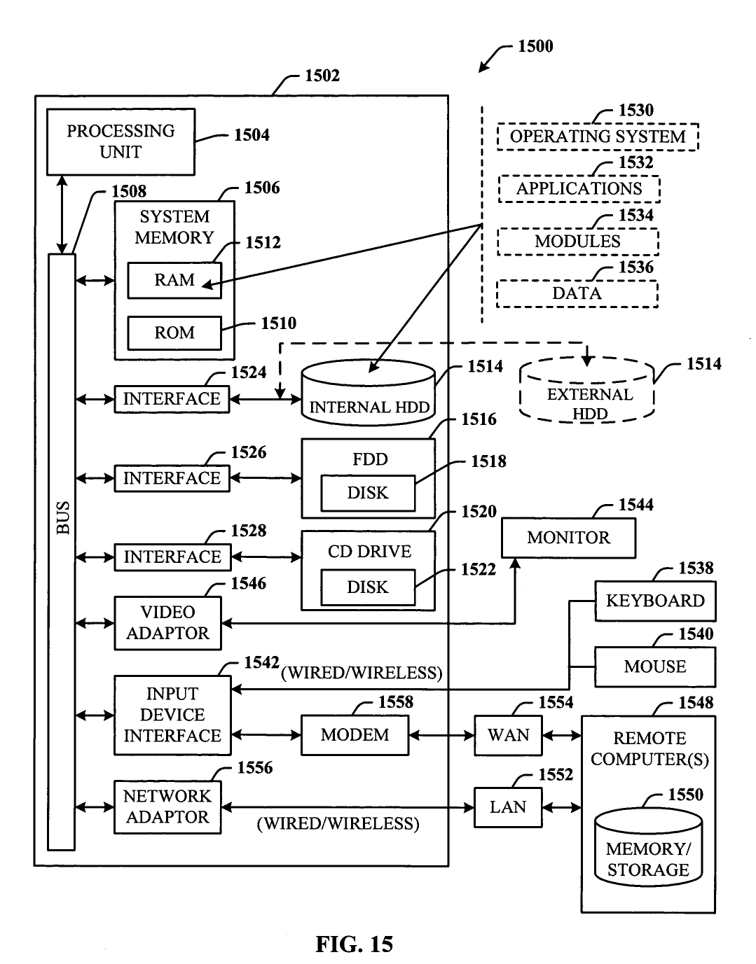

Referring now to FIG. 15, there is illustrated a block diagram of a computer operable to execute the disclosed architecture. In order to provide additional context for various aspects of the invention, FIG. 15 and the following discussion are intended to provide a brief, general description of a suitable computing environment 1500 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 15, there is illustrated an exemplary environment 1500 for implementing various aspects of the invention that includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is appreciated that the invention can be implemented with various commercially available operating systems or combinations of operating systems.

A user can enter commands and information into the computer 1502 through one or more wired/wireless input devices, e.g., a keyboard 1538 and a pointing device such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1502 is connected to the local network 1552 through a wired and/or wireless communication network interface or adapter 1556. The adaptor 1556 may facilitate wired or wireless communication to the LAN 1552, which may also include a wireless access point disposed thereon for communicating with the wireless adaptor 1556. When used in a WAN networking environment, the computer 1502 can include a modem 1558, or is connected to a communications server on the LAN, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate or with products that contain both bands (dual band), so the networks can provide real-world performance similar to the basic 10BaseT wired Ethernet networks used in many offices.

Aspects of the invention described above may be stored or distributed on computer-readable media, including magnetic and optically readable and removable computer discs, as well as distributed electronically over the Internet or over other networks (including wireless networks). Those skilled in the relevant art will recognize that portions or embodiments of the invention may reside in a fixed element of a communication network, while corresponding portions may reside on a mobile communication device. Data structures and transmission of data particular to aspects of the invention are also encompassed within the scope of the invention.

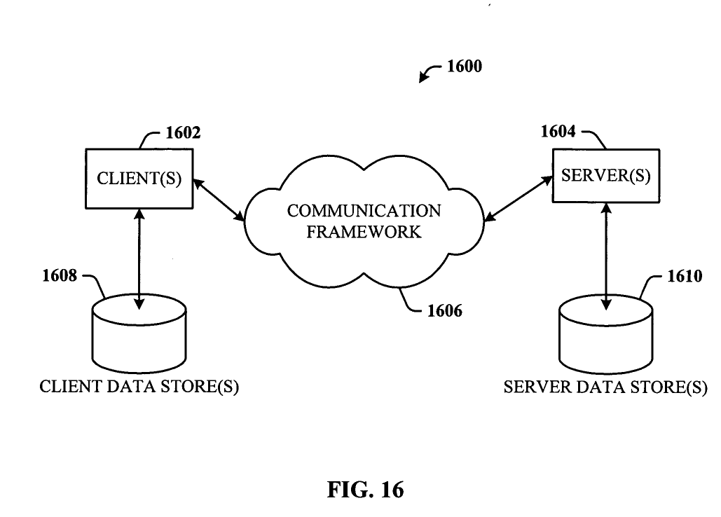

Referring now to FIG. 16, there is illustrated a schematic block diagram of an exemplary computing environment 1600 that can accommodate the business model in accordance with the invention. The system 1600 includes one or more client(s) 1602. The client(s) 1602 can be hardware and/or software (e.g., threads, processes, computing devices). The client(s) 1602 can house cookie(s) and/or associated contextual information by employing the invention, for example. The system 1600 also includes one or more server(s) 1604. The server(s) 1604 can also be hardware and/or software (e.g., threads, processes, computing devices). The servers 1604 can house threads to perform transformations by employing the invention, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates the management of services of a dedicated wireless device, comprising:
a business model component that provides limited/unlimited messaging services and accounting services for the dedicated wireless device.

2. The system of claim 1, wherein the business model component further comprises a post-payment billing component that facilitates a postpaid billing plan that pays for services rendered.

3. The system of claim 1, wherein the business model component further comprises a pre-payment billing component that facilitates a prepaid billing plan that pays for services to be rendered.

4. The system of claim 1, wherein the business model component includes a support component that facilitates accessing customer support via the wireless messaging device.

5. The system of claim 1, wherein the business model component includes an optional services component that facilitates the selection of additional services.

6. The system of claim 1, wherein the business model component includes a service interruption component that processes service suspension and resumption.

7. The system of claim 1, wherein the business model component includes a third-party component that facilitates communications with third-party portals and payments apportioned to the third-party portals thereto in accordance with services provided thereby.

8. The system of claim 1, wherein the business model component further comprises a charging cycle component that determines a charging cycle that is applied to at least one of the limited and unlimited messaging services.

9. The system of claim 1, wherein the business model component includes a charging cycle component that imposes a daily recurring charge that is additional to a normal billing charge.

10. The system of claim 1, wherein the business model component further comprises a restrictions component that determines if the dedicated wireless device meets predetermined criteria for operating in accordance with the limited and unlimited messaging services.

11. The system of claim 1, wherein the business model component further comprises a restrictions component that limits access to at least one of the limited messaging services and unlimited messaging services of an existing subscriber plan.

12. A server that employs the business model of claim 1.

13. The system of claim 1, wherein the business model component further comprises an accounts analysis component that employs a probabilistic and/or statistical-based analysis to prognose or infer an action that a user desires to be automatically performed.

14. A system that facilitates the management of services of a wireless messaging device, comprising:
a basic services component that provides limited and unlimited messaging services solely for the wireless messaging device;
an accounts component that tracks usage of an account of a subscriber; and
a payment component that facilitates applying a postpaid plan that automatically pays for the messaging services according to a monthly recurring charge (MRC) based on the account usage of the subscriber.

15. The system of claim 14, further comprising a support component that facilitates customer support of the wireless device.

16. The system of claim 14, further comprising an optional services component that facilitates the selection of additional services billed according to at least one of an additional MRC, a per-use billing, and volume-based billing.

17. The system of claim 14, further comprising a service interruption component that processes service suspension and resumption.

18. The system of claim 14, further comprising a third-party component that facilitates communications with third-party portals and payments apportioned to the third-party portals thereto in accordance with services provided thereby.

19. The system of claim 14, wherein the business model component includes a charging cycle component that imposes a daily recurring charge that is additional to the MRC.

20. The system of claim 14, further comprising a restrictions component that determines if the wireless messaging device meets predetermined criteria for operating in accordance with the limited and unlimited messaging services and limits access to at least one of the limited messaging services and unlimited messaging services of an existing subscriber plan.

21. A server that employs the business model of claim 14.

22. A computer readable medium having stored thereon computer executable instructions for carrying out the system of claim 14.

23. A system that facilitates the management of services of a wireless messaging device, comprising:
a basic services component that provides limited and unlimited messaging services solely for the wireless messaging device;
an accounts component that tracks usage of an account of a subscriber; and
a payment component that facilitates applying a prepaid plan that automatically pays for the messaging services based on a recurring charge according to the account usage of the subscriber.

24. The system of claim 23, further comprising a support component that facilitates customer support of the wireless device.

25. The system of claim 23, further comprising an optional services component that facilitates selection of additional services.

26. The system of claim 23, further comprising a service interruption component that processes service suspension and resumption.

27. The system of claim 23, further comprising a billing method component that facilitates payment by at least one of electronic funds transfer (EFT), recurring credit card, debit card, check, and stored-value account payment.

28. The system of claim 23, wherein the limited and unlimited messaging services are charged according to a daily recurring charge (DRC).

29. The system of claim 23, further comprising adding international mobile-originated (MO) short message service (SMS) messages for an additional fee.

30. A system that facilitates the management of wireless services of a wireless messaging device, comprising:
a message service component that enables communication of an SMS signal of a domestic MO message with an SMS provider;
a message service component that enables communication of an SMS signal of a domestic mobile-terminated (MT) message with an SMS provider;
an e-mail service component that enables communication of an e-mail message via at least one e-mail provider;
an instant messaging (IM) service component that enables IM communications with an IM provider;
a value-added service component that enables communication with a third-party portal provider; and
a single recurring charge that is imposed periodically on a user account in a post-paid manner for at least one of the services related to the SMS signals, the e-mail message, the IM service, and the third-party portal provider.

31. The system of claim 30, wherein at least one of the MO message and the MT message services accommodates an unlimited number of corresponding SMS messages.

32. The system of claim 30, wherein the e-mail service enables an unlimited number of e-mail messages.

33. The system of claim 30, wherein the e-mail service facilitates e-mail messaging with an existing account of the user.

34. The system of claim 30, wherein the e-mail service facilitates e-mail messaging with an existing Internet-accessible POP3 account of the user.

35. The system of claim 30, wherein the e-mail service prohibits an attachment to an e-mail message.

36. The system of claim 30, wherein the IM service facilitates an unlimited number of IM messages.

37. The system of claim 30, wherein the single recurring charge is a monthly recurring charge.

38. The system of claim 30, wherein the value-added service includes at least one of an additional e-mail account and an additional IM account.

39. The system of claim 30, the value-added service provides access to an additional third-party portal provided that is charged according to an additional fee.

40. The system of claim 30, further comprising a message service that enables international mobile-originated SMS messages.

41. The system of claim 40, wherein the message service for the international SMS messages is charged according to an additional fee.

42. The system of claim 30, further comprising a voice service that facilitates processing voice communications via the wireless messaging device for an additional fee.

43. The system of claim 30, wherein the wireless messaging device is a dedicated messaging-centric device.

44. A system that facilitates the management of wireless services of a wireless messaging device, comprising:
a message service component that enables unlimited domestic MO and MT SMS messaging;
an e-mail service component that enables communication of an unlimited number of e-mail messages via an existing subscriber POP3 e-mail account;
an IM service component that enables IM communications of an unlimited number of IM messages via an IM provider;
an included value-added service that enables communications via a third-party portal provider of at least one of IM and e-mail;
a charging cycle component that facilitates a single MRC that is imposed periodically on a user account in a post-paid manner for at least one of the services related to SMS messaging, the e-mail messages, the IM messages, and the included value-added service; and
an optional value-added service that enables communication via the third-party portal provider for an additional fixed MRC.

45. The system of claim 44, wherein the e-mail service component prohibits an attachment to an e-mail message.

46. The system of claim 44, further comprising a message service component that enables international MO SMS messages according to an additional fee.

47. The system of claim 44, further comprising an optional service component that facilitates adding voice communications capability to the wireless messaging device for an additional fee.

48. The system of claim 44, wherein the wireless messaging device is a dedicated messaging-centric device.

49. The system of claim 44, where the charging cycle component limits the amount of money that can be spent by the user account.

50. A system that facilitates the management of wireless messaging, comprising:
a wireless messaging-centric device that communicates messages; and
a messaging infrastructure dedicated to providing messaging services in association with the messaging-centric device, the infrastructure comprising,
a message service component that enables unlimited domestic MO and MT SMS messaging;
an e-mail service component that enables communication of an unlimited number of e-mail messages via an existing subscriber POP3 e-mail account;
an IM service component that enables IM communications of an unlimited number of IM messages via an IM provider;
an included value-added service that enables communication via a third-party portal provider of at least one of IM and e-mail;
a charging cycle component that facilitates a single MRC that is imposed periodically on a user account in a post-paid manner for at least one of the services related to the SMS messaging, the e-mail messages, the IM messages, and the included value-added service; and
an optional value-added service that enables communication via a third-party portal provider for an additional fixed MRC.

51. A method of facilitating management of wireless messaging, comprising:
providing a business model that facilitates limited/unlimited messaging services and accounting services for a dedicated wireless messaging device, which business model includes,
providing SMS services that include unlimited domestic MO and MT SMS messaging traffic;
providing an e-mail service that includes unlimited e-mail traffic via one or more existing subscriber e-mail accounts;
providing an IM service that includes unlimited IM traffic;
providing an included value-added portal service of at least one of an additional IM portal, and an additional e-mail portal;
providing a post-payment billing plan that facilitates paying for services and activity on the subscriber account; and
providing a single MRC that is imposed periodically on the subscriber account in a post-paid manner for at least one of the SMS services, the e-mail service, the IM service, and the included value-added service.

52. The method of claim 51, further comprising providing a support service that facilitates accessing customer support via the wireless messaging device.

53. The method of claim 51, further comprising processing restrictions that determine if the wireless messaging device meets predetermined criteria for operating the wireless messaging device in accordance with the limited/unlimited messaging services.

54. The method of claim 51, further comprising providing an option for optional services that facilitates the selection of additional services.

55. The method of claim 51, further comprising providing a service interruption component that processes service suspension and resumption.

56. The method of claim 51, further comprising imposing restrictions that limit access to limited/unlimited messaging services.

57. The method of claim 51, further comprising providing a pre-payment billing plan that prepays for services to be rendered.

58. The method of claim 51, further comprising remitting a portion of at least one of the MRC and a DRC to a third-party portal provider for allowing access to associated portal services.

59. A method of facilitating management of wireless messaging, comprising:
providing a business model that facilitates limited/unlimited messaging services and accounting services for a dedicated wireless messaging device, which business model includes,
providing SMS services that include unlimited domestic MO and MT SMS messaging traffic;
providing an e-mail service that includes unlimited e-mail traffic via one or more existing subscriber e-mail accounts;
providing an IM service that includes unlimited IM traffic;
providing an included value-added portal service of at least one of an additional IM portal, and an additional e-mail portal;
providing a post-payment billing plan that facilitates paying for services and activity on the subscriber account; and
providing a DRC that is imposed on the subscriber account in a pre-paid manner that subtracts funds from the subscriber account for at least one of the SMS services, the e-mail service, the IM service, and the included value-added service.

60. The method of claim 59, further comprising providing a support service that facilitates accessing customer support via the wireless messaging device.

61. The method of claim 59, further comprising processing restrictions that determine if the wireless messaging device meets predetermined criteria for operating the wireless messaging device in accordance with the limited/unlimited messaging services.

62. The method of claim 59, further comprising providing an option for optional services that facilitates the selection of additional services.

63. The method of claim 59, further comprising providing a service interruption component that processes service suspension and resumption.

64. The method of claim 59, further comprising imposing restrictions that limit access to limited/unlimited messaging services.

65. The method of claim 59, further comprising providing a pre-payment billing plan that prepays for services to be rendered.

66. The method of claim 59, further comprising remitting a portion of at least one of the MRC and a DRC to a third-party portal provider for allowing access to associated portal services.
